(19) United States
(12) Patent Application Publication
(10) Pub. No.: US 2013/0251493 A1
(43) Pub. Date: Sep. 26, 2013

(54) STACKING DEVICE AND AIR PURIFICATION SYSTEM THEREOF

(71) Applicants: Erqing Zhu, Shenzhen (CN); Chun Hao Wu, Shenzhen (CN); Kun Hsien Lin, Shenzhen (CN); Yongqiang Wang, Shenzhen (CN); Weibing Yang, Shenzhen (CN); Xiande Li, Shenzhen (CN)

(72) Inventors: Erqing Zhu, Shenzhen (CN); Chun Hao Wu, Shenzhen (CN); Kun Hsien Lin, Shenzhen (CN); Yongqiang Wang, Shenzhen (CN); Weibing Yang, Shenzhen (CN); Xiande Li, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/510,582

(22) PCT Filed: Apr. 1, 2012
(86) PCT No.: PCT/CN2012/073454

§ 371 Date: May 17, 2012

(30) Foreign Application Priority Data
Mar. 26, 2012 (CN) 201210082665.2

(51) Int. Cl. B65G 57/00; B01D 46/42

(52) U.S. Cl. 414/788.1; 55/473

(57) ABSTRACT

The present invention discloses a stacking device and an air purification system thereof. The stacking device includes vertically arranged stacking arms and a manipulator mechanism provided on the stacking arms; the stacking arms forming an axially extending duct and comprising first airflow driving devices; the duct forming air inflow openings that are in communication with an outside space of the stacking arms and an air outflow opening arranged at a lower end of the stacking arms; wherein the first airflow driving devices draw in air of the outside space of the stacking arms through the air inflow openings of the duct and drive air inside the duct to flow downward to be discharged through the air outflow opening of the duct to the lower end of the stacking arms.

### BACKGROUND OF THE INVENTION

1. Field of the Invention

The present invention relates to the field of industrial installations, and in particular to a stacking device and an air purification system thereof.

2. The Related Arts

A stacking device is a high cleanness installation. As shown in FIGS. 1 and 2, a conventional stacking device 10 comprises a housing 14, two vertical stacking arms 11 arranged inside the housing 10, cartridges 13 arranged inside the housing 14, and a plurality of fan filter devices 12 arranged on a surface of the housing 14. The two stacking arms 14 are provided with manipulator mechanisms (not shown).

Arrows shown in FIG. 1 indicate the direction of air flow. In a still condition, the operation of the fan filter devices 12 is capable of keeping high cleanness inside the stacking device 10. However, when the stacking device 10 is put into operation, dusts may be lifted and floating on the bottom of the device and causes contamination of the cartridges 13 that is located inside the housing 14 and products, such as glass, received in the cartridges 13, thereby affecting the yield rate of product.

Thus, it is desired to have a stacking device and an air purification system applicable to the stacking device to handle the above problems.

### SUMMARY OF THE INVENTION

The technical issue to be addressed by the present invention is to provide a stacking device and an air purification system thereof, which reduce lifted dust in the operation of the stacking device and thus improve the yield rate of product.

To address the above technical issue, the present invention adopts a technical solution by providing a stacking device. The device comprises: vertically arranged stacking arms and a manipulator mechanism provided on the stacking arms; the stacking arms forming an axially extending duct and comprising first airflow driving devices; the duct forming in a side wall thereof a plurality of vertically distributed air inflow openings that are in communication with an outside space of the stacking arms and an air outflow opening arranged at a lower end of the stacking arms; a first ceiling, which is arranged above the stacking arms and is provided with a plurality of second airflow driving devices, the plurality of second airflow driving devices drawing in and driving airflow into interior space of the stacking device; wherein the first airflow driving devices comprise fan filter devices with one fan filter device installed at each of the air inflow openings for drawing in air of the outside space of the stacking arms through the air inflow openings of the duct and driving air inside the duct to flow downward to be discharged through the air outflow opening of the duct to the lower end of the stacking arms.

Wherein, the manipulator mechanism comprises: a first conveyance module, which functions picks up a product and carries out raising and lowering operations and release of the product; the stacking device further comprising: a second conveyance module, which receives the product from the first conveyance module for carrying out loading and unloading of the product; and a machining module, which receives the product from the second conveyance module to carry out machining operation of the product.

Wherein, the second conveyance module comprises: a carrier unit, which receive the product from the first conveyance module; a storage unit, which receives the product from the carrier unit; and a transportation unit, which picks up the product from the storage unit and transfers the product to the machining module.

Wherein, the transportation unit comprises an industrial robot.

Wherein, the second conveyance module and the machining module are arranged at each of two sides of the stacking arms.

To address the above technical issue, the present invention adopts another technical solution by providing a stacking device. The device comprises vertically arranged stacking arms and a manipulator mechanism provided on the stacking arms; the stacking arms forming an axially extending duct and comprising first airflow driving devices; the duct forming air inflow openings that are in communication with an outside space of the stacking arms and an air outflow opening arranged at a lower end of the stacking arms; wherein the first airflow driving devices draw in air of the outside space of the stacking arms through the air inflow openings of the duct and drive air inside the duct to flow downward to be discharged through the air outflow opening of the duct to the lower end of the stacking arms.

Wherein, the number of the first airflow driving device is plural of which at least some are installed at the air inflow openings of the duct to take a form of air suction for drawing in the air of the outside space of the stacking arms through the air inflow openings of the duct and at least some other are installed at the air outflow opening of the duct to take a form of blowing air for expelling air out of the duct through the air outflow opening.

Wherein, the first airflow driving devices comprise fan filter devices, the duct forming in a side wall thereof a plurality of vertically distributed air inflow openings, each of the fan filter devices being set correspond to each of the air inflow openings.

Wherein, the stacking device further comprises: a first ceiling, which is arranged above the stacking arms and is provided with a plurality of second airflow driving devices, the plurality of second airflow driving devices drawing in and driving airflow into interior space of the stacking device.

Wherein, the manipulator mechanism comprises: a first conveyance module, which functions picks up a product and carries out raising and lowering operations and release of the product; the stacking device further comprising: a second conveyance module, which receives the product from the first conveyance module for carrying out loading and unloading of the product; and a machining module, which receives the product from the second conveyance module to carry out machining operation of the product.

Wherein, the second conveyance module comprises: a carrier unit, which receive the product from the first conveyance module; a storage unit, which receives the product from the carrier unit; and a transportation unit, which picks up the product from the storage unit and transfers the product to the machining module.

Wherein, the transportation unit comprises an industrial robot.

Wherein, the second conveyance module and the machining module are arranged at each of two sides of the stacking arms.

To address the above technical issue, the present invention adopts a further technical solution by providing an air purification system for use in a stacking device. The system comprises: an axially extending duct formed along a stacking arm of the stacking device and a first airflow driving device; and the duct forming an air inflow opening communicating with an outside space of the stacking arm and an air outflow opening formed at a lower end of the stacking arm; wherein the first airflow driving device draws in air of the outside space of the stacking arm through the air inflow opening of the duct and drives air inside the duct to flow downward to be discharged through the air outflow opening of the duct to the lower end of the stacking arm.

Wherein, the number of the first airflow driving device is plural of which at least some are installed at the air inflow opening of the duct to take a form of air suction for drawing in the air of the outside space of the stacking arm through the air inflow opening of the duct and at least some other are installed at the air outflow opening of the duct to take a form of blowing air for expelling air out of the duct through the air outflow opening.

The efficacy of the present invention is that to be distinguished from the state of the art, the present invention forms a duct in a stacking arm and comprises a first airflow driving device so as to use the first airflow driving device to draw lifted and floating dust into a duct and to drive the air contained in the duct to move downward in order to be discharged to a lower end of stacking arm through an air outflow opening of the duct thereby reducing lifting of dust in the movement of the stacking device and improving yield rate of product.

### BRIEF DESCRIPTION OF THE DRAWINGS

FIG. 1 is a schematic view showing a known stacking device;

FIG. 2 is a schematic view showing stacking arms of the stacking device shown in FIG. 1;

FIG. 3 is a schematic view showing a stacking device according to a first embodiment of the present invention; and

FIG. 4 is a schematic view showing stacking arms and an air purification system of the stacking device shown in FIG. 3.

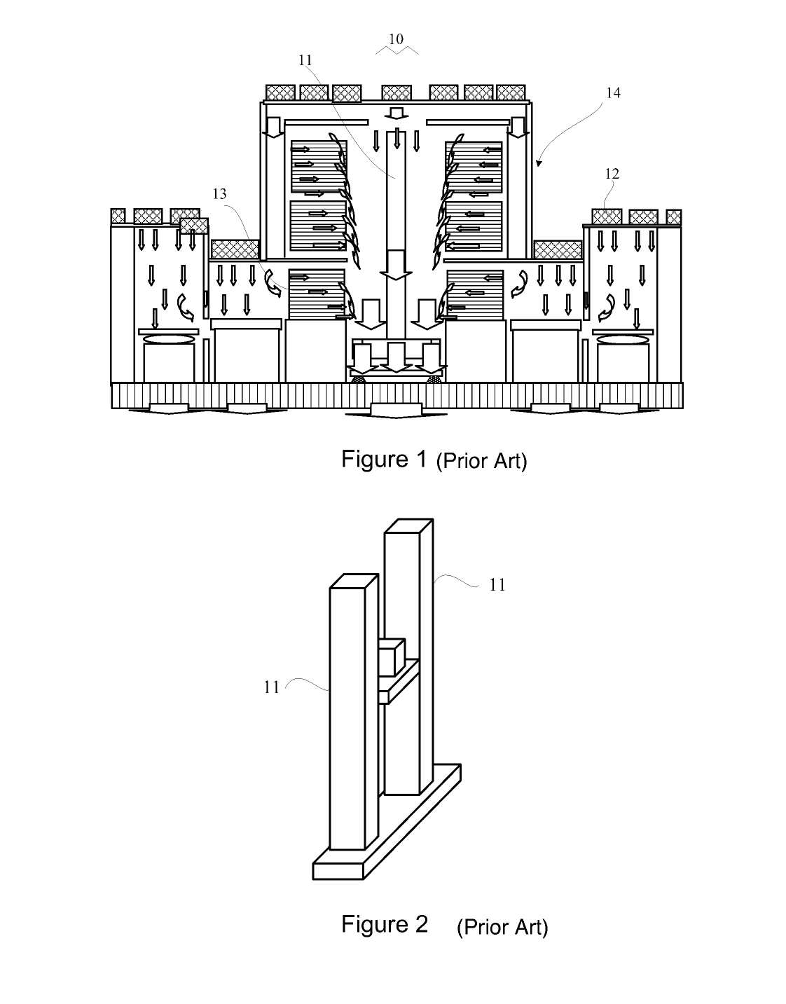

### DETAILED DESCRIPTION OF THE PREFERRED EMBODIMENTS

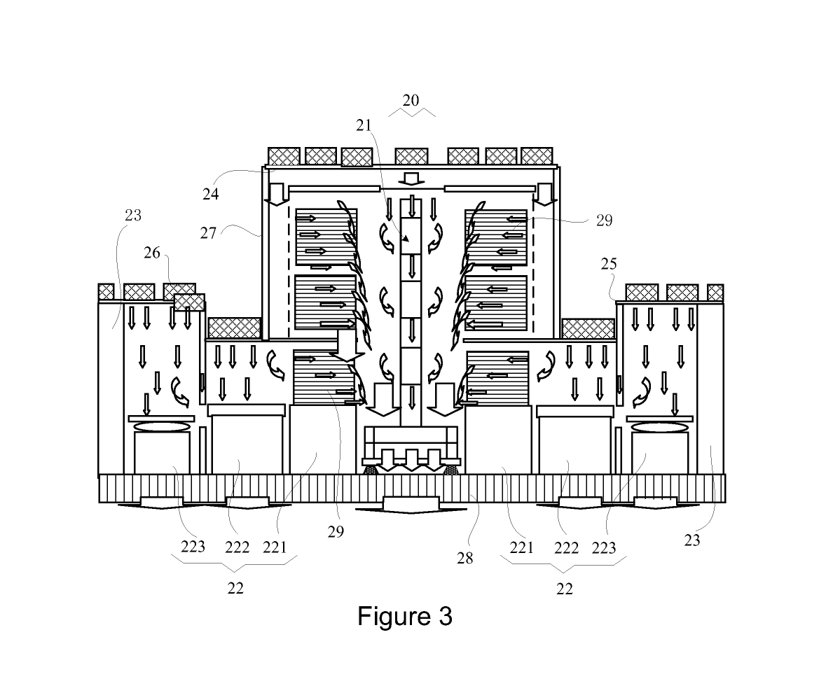

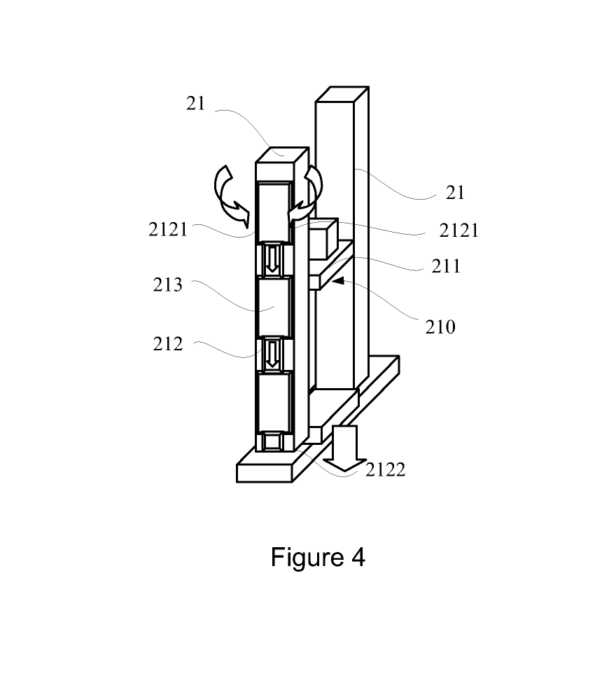

Referring to FIGS. 3 and 4, which are respectively a schematic view showing a stacking device according to a first embodiment of the present invention and a schematic view showing stacking arms and an air purification system of the stacking device shown in FIG. 3, the stacking device 20 according to the first embodiment of the present invention generally comprise two stacking arms 21, second conveyance modules 22, machining modules 23, a first ceiling 24, second ceilings 25, side walls 27, and a chassis 28. The second conveyance modules 22 and the machining modules 23 are arranged at both sides of the two stacking arms 21. In other embodiments of the present invention, it is also feasible to only arrange the second conveyance module 22 and the machining module 23 at one side of the two stacking arms 21.

The first ceiling 24 is arranged above the stacking arms 21 and the second ceilings 25 are respectively arranged at opposite sides of the first ceiling 24.

The side walls 27 function to isolate the atmosphere outside the stacking device 20 and the internal air thereof from each other. The chassis 28 functions to carry thereon the stacking device 20.

The two stacking arms 21 are arranged vertically and parallel to each other. Further, the two stacking arms 21 are provided with a manipulator mechanism 210. The manipulator mechanism 210 is supported and guided by the two stacking arms 21 to vertically move up and down. Further, the manipulator mechanism 210 is movable and rotatable with horizontal displacement and rotation of the stacking arms 21. When the manipulator mechanism 210 reaches a target position through horizontal displacement, rotation, and vertical movement, an operation of pick up and release a product can be carried out.

Specifically, the manipulator mechanism 210 comprises a first conveyance module 211, which functions to pick up a product and performs raising and lowering operation and release operation on the product. In an operation process, the manipulator mechanism 210 precisely picks up a cartridge 29 fro a storage section of the stacking device 20. The cartridge 29 contains therein a product (not shown). And, then the cartridge 29 is transferred to the second conveyance module 22 for loading/unloading of the product contained in the cartridge 29 and the product is then transferred to the machining module 23 for machining operation. Or alternatively, the manipulator mechanism 210 picks up the cartridge 29 from the second conveyance module 22 and place the cartridge to the storage section or other sections.

The second conveyance module 22 comprises: a carrier unit 221, a storage unit 222, and a transportation unit 223. The carrier unit 221 functions to receive the cartridge 29 transferred from the first conveyance module 211 and unloads the product from the cartridge 29 and then transfers the product, by means of a transferring device (not shown), to the storage unit 222. The transportation unit 223 picks up the product from the storage unit 222 to transfer to the machining module 23 for carrying out a machining operation. In a preferred embodiment of the present invention, the conveyance module 223 comprises an industrial robot.

Further, axially extending along one or two stacking arms 21 of the stacking device 20 are a duct 212 and a plurality of first airflow driving devices 213 that constitute an air purification system. The duct 212 comprises an air inflow opening 2121 in communication with an outside space of the stacking arms 21 and an air outflow opening 2122 arranged at a lower end of the stacking arm 21. The first airflow driving devices 213 function to draw in air of the outside space of the stacking arms 21 through the air inflow opening 2121 of the duct 212 and drive the air inside the duct 212 to flow downward to be discharged to the lower end of the stacking arms 21 through the air outflow opening 2122 of the duct 212 to be further discharged out of the air purification system. In a preferred embodiment of the present invention, the number of the first airflow driving devices 213 is plural and at least some are installed at the air inflow opening 2121 of the duct 212 for drawing in air of the outside space of the stacking arms 21 through the air inflow opening 2121 of the duct 212 and the remaining ones are installed at the air outflow opening 2122 of the duct 212 to blow and thus discharge air that are inside the duct 212 out through the air outflow opening 2122.

In a practical application, the first airflow driving devices 213 comprise fan filter devices, and the duct 212 forms, in a side wall thereof, vertically distributed air inflow openings 2121 with the first airflow driving devices 213 respectively installed at each of the air inflow openings 2121. The number of the first airflow driving devices 213 used is determined according to practical needs and other devices that provide the same function as the fan filter device can be used to replace the fan filter device.

Apparently, in other practical applications of the present invention, it is possible to install only one first airflow driving device 213. For example, the single first airflow driving device 213 is installed at a location between the air outflow opening 2122 and the one of the air inflow openings 2121 that is closest to the air outflow opening 2122.

During the movement of the stacking device 20, dusts are lifted and floating. The first airflow driving device 213 that is installed at the air inflow opening 2121 of the duct 212 takes the form of suction to draw in air of the outside space of the stacking arms 21 that carries dusts through the air inflow opening 2121 of the duct 212 and the first airflow driving device 213 installed at the air outflow opening 2122 of the duct 212 takes the form of blowing to expel air contained in the duct 212 outward through the air outflow opening 2122 to be further discharged through the chassis 28 to the outside space of the stacking device 20 in order to keep high cleanness inside the interior space of the stacking device 20 to thereby improve yield rate of product.

Further, the first ceiling 24 and the second ceilings 25 are provided with a plurality of second airflow driving devices 26. The second airflow driving devices 26 function to draw in clean airflow and drive the airflow into the interior space of the stacking device 20. In a practical application, the second airflow driving devices 26 comprise fan filter devices. In other applications, other device having the same function as the fan filter devices 26 may be used to substitute the fan filter devices 26.

To be distinguished from the state of the art, the present invention uses a first airflow driving device to drive air contained in a duct to move downward in order to be discharged to a lower end of stacking arms through an air outflow opening of the duct thereby reducing lifting of dust in the movement of the stacking device and improving yield rate of product.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

1. A stacking device, comprising:
vertically arranged stacking arms and a manipulator mechanism provided on the stacking arms;
the stacking arms comprising an axially extending duct that is fixed to one of the stacking arms and comprising first airflow driving devices;
the duct forming in a side wall thereof a plurality of air inflow openings that are distributed along the duct and are in communication with an outside space of said one of the stacking arms and an air outflow opening fixedly arranged at a lower end of said one of the stacking arms;
a first ceiling, which is arranged above the stacking arms and is provided with a plurality of second airflow driving devices, the plurality of second airflow driving devices drawing in and driving airflow into interior space of the stacking device;
wherein the first airflow driving devices comprise fan filter devices with one fan filter device installed at each of the air inflow openings for drawing in air of the outside space of said one of the stacking arms through the air inflow openings of the duct and driving air inside the duct to flow downward to be discharged through the air outflow opening of the duct to the lower end of said one of the stacking arms.

2. The stacking device as claimed in claim 1, wherein the manipulator mechanism comprises:
a first conveyance module, which picks up a product and carries out raising and lowering operations and release of the product;
the stacking device further comprising:
a second conveyance module, which receives the product from the first conveyance module for carrying out loading and unloading of the product; and
a machining module, which receives the product from the second conveyance module to carry out machining operation of the product.

3. The stacking device as claimed in claim 2, wherein the second conveyance module comprises:
a carrier unit, which receive the product from the first conveyance module;
a storage unit, which receives the product from the carrier unit; and
a transportation unit, which picks up the product from the storage unit and transfers the product to the machining module.

4. The stacking device as claimed in claim 3, wherein the transportation unit comprises an industrial robot.

5. The stacking device as claimed in claim 4, wherein the second conveyance module and the machining module are arranged at each of two sides of the stacking arms.

6. A stacking device, comprising:
vertically arranged stacking arms and a manipulator mechanism provided on the stacking arms;
the stacking arms comprising an axially extending duct that is fixed to one of the stacking arms and comprising first airflow driving devices;
the duct forming air inflow openings that are in communication with an outside space of said one of the stacking arms and an air outflow opening fixedly arranged at a lower end of said one of the stacking arms;
wherein the first airflow driving devices draw in air of the outside space of said one of the stacking arms through the air inflow openings of the dduct and drive air inside the duct to flow downward to be discharged through the air outflow opening of the duct to the lower end of said one of the stacking arms.

7. The stacking device as claimed in claim 6, wherein the number of the first airflow driving device is plural of which at least some are installed at the air inflow openings of the duct to take a form of air suction for drawing in the air of the outside space of the stacking arm through the air inflow openings of the duct and at least some other are installed at the air outflow opening of the duct to take a form of blowing air for expelling air out of the duct through the air outflow opening.

8. The stacking device as claimed in claim 7, wherein the first airflow driving devices comprise fan filter devices, the duct forming in a side wall thereof a plurality of vertically distributed air inflow openings, each of the fan filter devices being set to correspond to each of the air inflow openings.

9. The stacking device as claimed in claim 6, wherein the stacking device further comprises:
a first ceiling, which is arranged above the stacking arms and is provided with a plurality of second airflow driving devices, the plurality of second airflow driving devices drawing in and driving airflow into interior space of the stacking device.

10. The stacking device as claimed in claim 6, wherein the manipulator mechanism comprises:
a first conveyance module, which picks up a product and carries out raising and lowering operations and release of the product;
the stacking device further comprising:
a second conveyance module, which receives the product from the first conveyance module for carrying out loading and unloading of the product; and
a machining module, which receives the product from the second conveyance module to carry out machining operation of the product.

11. The stacking device as claimed in claim 10, wherein the second conveyance module comprises:
a carrier unit, which receive the product from the first conveyance module;
a storage unit, which receives the product from the carrier unit; and
a transportation unit, which picks up the product from the storage unit and transfers the product to the machining module.

12. The stacking device as claimed in claim 11, wherein the transportation unit comprises an industrial robot.

13. The stacking device as claimed in claim 12, wherein the second conveyance module and the machining module is arranged at each of two sides of the stacking arms.

14. An air purification system for use in a stacking device, comprising:
an axially extending duct formed along and fixed to a stacking arm of the stacking device and a first airflow driving device; and
the duct comprising an air inflow opening communicating with an outside space of the stacking arm and an air outflow opening fixedly arranged at a lower end of the stacking arm;
wherein the first airflow driving device draws in air of the outside space of the stacking arm through the air inflow opening of the duct and drives air inside the duct to flow downward to be discharged through the air outflow opening of the duct to the lower end of the stacking arm.

15. The air purification system as claimed in claim 14, wherein
the number of the first airflow driving device is plural of which at least some are installed at the air inflow opening of the duct to take a form of air suction for drawing in the air of the outside space of the stacking arm through the air inflow opening of the duct and at least some other are installed at the air outflow opening of the duct to take a form of blowing air for expelling air out of the duct through the air outflow opening.
